(19) United States
(12) Patent Application Publication
(10) Pub. No.: US 2002/0138360 A1
(43) Pub. Date: Sep. 26, 2002

(54) Distribution support equipment

(76) Inventors: Makoto Inoue, Osaka (JP); Kimio Ariga, Osaka (JP); Tsuguharu Nishizaki, Osaka (JP); Katsumi Ueno, Osaka (JP); Takuya Morikawa, Osaka (JP); Nobuhiko Hasegawa, Osaka (JP); Kazuto Yamano, Osaka (JP); Takeshi Iwasaki, Osaka (JP)

Correspondence Address: Frank D Wolffe, Banner & Witcoff, Eleventh Floor, 1001 G Street NW, Washington, DC, 20001-4597, US

(21) Appl. No.: 09/936,900

(22) PCT Filed: Jan. 19, 2001
(86) PCT No.: PCT/JP01/00323

(30) Foreign Application Priority Data
Jan. 21, 2000 (JP) 2000-12949

(51) Int. Cl. G06F 17/60

(52) U.S. Cl. 705/26

(57) ABSTRACT

By supporting distribution related to an overall business dealing among customers CMR, plural distributors including dealers SHP, and suppliers SPR with use of a computer system CS through communication network, the merchandise supplier side including the distributors SHP or WS and suppliers SPR can simplify its own merchandise distribution process and save labor required for tasks due for the merchandise distribution process, while the customer CMR side can simplify the ordering management, ordering operations and the like.

### TECHNICAL FIELD

The present invention relates to distribution support equipment run with use of a computer system and customer-side equipment accessible to this computer system through a communication channel for supporting distributions related to business transactions for providing merchandise or services among customers, distributors such as dealers and wholesalers, and suppliers.

### BACKGROUND ART

Recently, utilization of the internet by the public has become easy and on-line shopping utilizing a computer system equipped with a WWW server and personal computers owned by end users is growing.

Under such circumstances, there is devised on-line distribution support equipment constructed basing upon the existing business transaction system in which intermediate distributors intervene between suppliers and demanders. This equipment is designed to allow dealers directly connected to users such as general retail shops or special agents to attend to this system as well as to take advantages of the information providing property and the convenience of the internet, thereby enabling such users to obtain professional supports or services from existing dealers. One known example of such equipment is for members mainly gathered and invited from users through individual dealers and enables on-line shopping like catalog shopping to be realized by utilizing user-side equipment such as personal computers owned by the members and a computer system on the network center side.

With such equipment, however, ordering operations are very complicated and cumbersome for the users when each user wishes to order diversified merchandise items belonging to different categories because, for example, orders for merchandise items of different categories must be separately made to different dealers. Further, there may be a case where any cost reduction cannot be achieved because of wastefulness which may result from forwarding and receiving of debit notes, detailed statements, statements of delivery and the like due in business transactions and in delivering goods.

That is, such a conventional internet business transaction is a system in which a single dealer deals with the users and which, basically, merely forms part of an actual business dealing in which a plurality of distributors including dealers or wholesalers and a plurality of suppliers participate. Therefore, such a system may suffer from an inconvenience such that it cannot adequately cope with diversified business activities and, hence, wastefulness results.

### DISCLOSURE OF INVENTION

In pursuit of resolving the problems described above, the present invention mainly intends to improve the efficiency and cost reduction of an overall business dealing without impairing advantages of the existing business system in which intermediate distributors are involved. Specifically, the present invention is to simplify the merchandise distribution process itself and save labor in tasks required for the merchandise distribution process in the interest of the merchandise supplier side including distributors, suppliers and the like and to simplify the ordering management, ordering operations and the like in the interest of the customer side by supporting an overall business dealing among a customer, a plurality of distributors such as dealers, and a plurality of suppliers using a computer system via communication network.

As shown in FIG. 1, distribution support equipment according to the present invention is configured to be run with use of a computer system CS and a customer-side equipment P1 accessible to the computer system CS through a communication line for supporting distribution related to business dealings among customers CMR, distributors including a dealer SHP and a wholesaler WS, and suppliers SPR and is characterized by comprising customer specifying means 1 for specifying a customer CMR who has made access to the computer system CS from the customer-side equipment P1, route specifying means 2 for specifying each of merchandise distribution routes MR for plural sorts of merchandise by separating one route from another upon receipt of order signals from the customer CMR identified by the customer specifying means 1 to deliver the plural sorts of merchandise to the customer CMR, and information processing means 3 for making arrangements for providing the customer CMR with merchandise items meeting the order signals through respective merchandise distribution routes MR specified by the route specifying means 2.

With this equipment, each customer CMR can place orders for plural sorts of merchandise at a time even if the merchandise categories and merchandise distribution routes MR thereof are completely different from each other, whereby the ordering operation can be rendered very simple. Further, the route specifying means 2 separates the merchandise distribution routes MR for respective merchandise items from each other and the information processing means 3 automates the process of distributing each merchandise item to the customer CMR through respective merchandise distribution route MR, whereby arrangements for merchandise, which have been made by an individual distributor such as a dealer SHP or a wholesaler WS and a individual supplier SPR separately, can be thoroughly eliminated or minimized.

That is, an overall actual business dealing in which plural distributors such as dealers SHP and plural suppliers SPR participate for a customer CMR can be supported, thereby rendering the merchandise distribution more efficient and promoting the cost reduction, labor saving and the like without impairing the advantages of the existing business dealing order. This advantage becomes highly noticeable particularly where the customer CMR is a group of customers such as a corporation dealing diversified amounts and sorts of merchandise.

As a specific embodiment of the route specifying means 2, there can be mentioned one which is configured to separate the merchandise routes MR from each other on the basis of the product number and category of each merchandise item according to predetermined settings.

For simplification of operations of ordering and receiving orders performed by dealers SHP and the like, the information processing means 3 is preferably provided with directed-at-dealer ordering means for automatically placing orders to dealers SHP serving as order receivers of respective merchandise routes MR according to order signals received from the customer CMR at a time, or directed-at-supplier and wholesaler ordering means for allowing a dealer having received orders from each customer to automatically place orders to different suppliers or wholesalers depending upon product numbers and categories of ordered merchandise items according to predetermined settings, or shipment instruction means for allowing a dealer SHP having received orders from each customer CMR to automatically give shipment instructions to different deliverers depending upon areas and ordered merchandise items according to predetermined settings.

In order to set a price of each ordered merchandise item on a customer-by-customer basis carefully to details as well as to promote labor saving in the price setting, the distribution support equipment is preferably provided with selling price setting means for automatically setting a final selling price of a merchandise item for a customer having made an order for the merchandise item by adding a profit ratio of a distributor SHP or WS involved in a merchandise distribution route MR specified by the route specifying means 2 to a selling price set by a supplier SPR.

Further, in order to afford convenience to the distributors SHP, WS and the supplier SPR by providing them with delivery information of a merchandise item thus arranged for, various sorts of information based on the delivery information, transaction documents or the like, the distribution support equipment is preferably provided with sales and buying management means for managing a unit selling price and a unit buying price for each distributor SHP or WS or supplier SPR according to predetermined settings while automatically providing each distributor with sales and buying information based on the delivery information, or billing support means for automatically calculating expenses and providing a billed part with information of the expenses thus calculated according to billing conditions stored in a billing condition database storing various billing conditions in relation to delivery, distribution and the like when the billed part wants the information, or billing and payment management support means for supporting billing and payment management at each supplier SPR or distributor SHP or WS on the basis of sales and buying information according to predetermined settings.

As an embodiment of the distribution support equipment capable of advantageously accommodating to the case where, for example, a customer CMR has a tie-up with a specific purchasing subsidiary serving as a dealer in relation to purchase of merchandise and the purchasing subsidiary shares the tasks for the customer CMR with a common dealer, there can be mentioned one which is provided with task apportion support means for allowing dealers SHP to apportion a power of setting in respect of sharing of tasks inherent to a dealer function including customer's ID setting, customer selling price setting and delivery condition setting on a task-by-task basis according to an agreement previously made between the plurality of dealers having overlapping tasks.

In order to contribute to labor saving of a customer CMR and afford largely improved convenience to the customer CMR by performing purchasing management due for the customer CMR, it is highly preferred that the distribution support equipment be provided with purchasing management means 17 as shown in FIG. 12 for automatically performing purchasing management of a customer CMR according to purchasing management conditions determined by a combination of the customer CMR and customer information specified by the customer specifying means 1 and the product number of an merchandise item ordered by the customer CMR.

As a specific embodiment of the purchasing management means 17 that is particularly effective for a group of customers CMR such as a corporation, there can be mentioned one which is provided with purchased merchandise classification management means for automatically setting and managing an account item code used in an organization to which the customer belongs depending upon a combination of a customer CMR specified by the customer specifying means 1, a budget management unit used in the organization to which the customer belongs, and the product number of a merchandise item ordered by the customer CMR, or approval route management means for automatically performing purchasing management related to a judgment as to whether or not approval is necessary, a maximum sum of money not requiring approval, an approver, an approval route and the like according to purchase regulations stipulated by the organization to which a customer CMR belongs, or power setting means for managing the entitlement of a customer CMR to placing orders in an organization to which the customer CMR belongs while judging whether each customer CMR is entitled to a referencing power or an ordering power.

As a preferred embodiment of the distribution support equipment for advantageously grasping the purchasing situation of a corporation as a whole and establishing a purchase budget of the corporation, there can be mentioned one in which the purchasing management means 17 is provided with manager support means for providing a manager in an organization to which a customer CMR belongs with purchasing information of each customer CMR in the organization thereby allowing the manager to conduct centralized management of a purchase budget of the organization.

Further, in order to afford improved ease in using the customer-side equipment P1, allow unnecessary functions to be eliminated according to the request of a customer CMR, and bring other advantages, it is preferable to provide customer-by-customer based menu management means for allowing a system manager or the like to customize the setting of a picture displayed on the customer-side equipment P1 and other necessary functions of the customer-side equipment on a customer-by-customer basis.

In order for a specially ordered merchandise item such as a name-attached product to be handled in the same manner as with other standard merchandise thereby flexibly accommodating to demands of a customer CMR, it is desirable that the distribution support equipment be provided with free form ordering means for allowing a customer CMR to designate a previously registered dealer SHP to which the customer CMR is capable of addressing an inquiry about an order for a merchandise item which has previously not been established through the customer-side equipment P1 as well as for performing sales management handling the merchandise item as a special handling merchandise item according to an agreement made between the customer CMR and the dealer SHP in relation to the inquiry.

Likewise, in order to flexibly accommodate to requests from a customer CMR and forms of use, it is preferred that the distribution support equipment be provided with customer-by-customer based merchandise setting means for establishing at least settings of original categories, names and the like of merchandise items on a customer-by-customer basis aside from categories and names of handeable merchandise items established in the computer system CS as well as for enabling merchandise item retrieval based on the setting thus made, or with customer's set product number management means for allowing a customer CMR to establish a plurality of product numbers as a set thereby enabling management based on a customer's single set product number and to place an order also based on the set product number.

On the other hand, for the distribution support equipment to become advantageous to the supplier side, it is sufficient to provide supplier's set product number management means for establishing a set of product numbers of plural merchandise items for which a supplier SPR is capable of receiving an order if the merchandise items are combined into a finished product and which are established as plural merchandise items in the computer system CS thereby enabling an order based on a single set product number.

For the delivery time management to be automatically performed, it is conceivable that the distribution support equipment is provided with automatic delivery time calculation means for automatically calculating a due date for delivery of a merchandise item ordered by a customer CMR by referencing at least delivery situation of a deliverer and working dates of the customer CMR. In this case, the equipment may be configured to check whether the merchandise item ordered by the customer CMR can be delivered to the customer CMR on a desired delivery date, if desired by the customer CMR, by utilizing the automatic delivery time calculation means.

As a specific embodiment for realizing smooth running and maintenance of the distribution support equipment according to the present invention, there can be mentioned one which is provided with application support means for registering an unspecified number of users having made contact with the computer system CS as customers CMR capable of business dealing though the computer system, the application support means having a function allowing a user to designate a specific dealer SHP by referencing data of dealers SHP previously registered when the user applies for registration, one which is provided with customer registration means for allowing a dealer SHP designated by a user to register the user as a customer of the dealer in the computer system CS, or one which is provided with merchandise information database maintenance means for storing information of handleable merchandise items in a merchandise information database incorporated in the computer system CS and allowing a supplier SPR contacting the computer system to register information of at least merchandise items supplied from the supplier SPR itself in the merchandise information database or renew the information registered in the database.

Further, in order to enhance the extensibility of the distribution support equipment of the present invention as well as to enable more flexible adaptability to customers CMR, distributors or the like, it is preferred that the distribution support equipment be provided with purchasing system linkage means for linking up with other distribution support equipment and providing customers CMR utilizing the other distribution support equipment with merchandise information stored in the computer system CS of the equipment of the present invention as information of an original merchandise assortment and purchase prices previously established on a customer-by-customer basis by matching merchandise categories established in the computer system CS with those established in the other distribution support equipment, or with supplier linkage means for linking up with a supplier SPR having an original computer system accumulating its own merchandise information to obtain the merchandise information through the computer system CS of the distribution support equipment. More specifically, there can be mentioned one in which the supplier linkage means is configured to enable the merchandise information accumulated in the supplier's computer system to be utilized as merchandise information of the computer system of the distribution support equipment by synchronizing the merchandise categories established in the computer system CS of the distribution support system with those established in the supplier's computer system and applying a ratio variable price established for each merchandise category to a selling price of a merchandise item belonging to each merchandise category established in the supplier's computer system.

On the other hand, as distribution support equipment which can accommodate to business and distribution in relation to provision of services as well as offer advantages similar to those described above, there can be mentioned one as shown in FIG. 3 configured to be run with use of a computer system CS and customer-side equipment P1 accessible to the computer system CS through a communication channel, the distribution support equipment comprising customer specifying means 1 for specifying a customer CMR who has made access to the computer system CS from the customer-side equipment P1, route specifying means 2 for specifying each of business transaction routes MR for plural sorts of services by separating one route from another upon receipt of order signals at a time from the customer CMR specified by the customer specifying means 1 to provide the customer CMR with the plural sorts of services, and information processing means 3 for making arrangements for providing the customer CMR with the services meeting the order signals through respective business transaction routes MR specified by the route specifying means 2.

When consideration is taken to afford more convenience to a customer CMR with the above configuration, it is preferred that the distribution support equipment be provided with purchasing management means 17 as shown in FIG. 4 for automatically performing purchasing management on a customer-by-customer basis according to preset purchasing management conditions determined by a combination of the customer CMR specified by the customer specifying means 1 and the sorts of services ordered by the customer CMR.

### BRIEF DESCRIPTION OF DRAWINGS

FIG. 1 is a diagram corresponding to an invention according to claim 1.

FIG. 2 is a diagram corresponding to an invention according to claim 11.

FIG. 3 is a diagram corresponding to an invention according to claim 29.

FIG. 4 is a diagram corresponding to an invention according to claim 30.

FIG. 5 is a diagram showing the overall configuration of one embodiment of the present invention.

FIG. 6 is a diagram showing the configuration of a computer system in the same embodiment.

FIG. 7 is a diagram illustrating the function of route specifying means in the same embodiment.

FIG. 8 is a diagram illustrating the function of directed-at-dealer ordering means in the same embodiment.

FIG. 9 is a diagram illustrating the function of directed-at-supplier and wholesaler ordering means in the same embodiment.

FIG. 10 is a diagram illustrating the function of selling price setting means in the same embodiment.

FIG. 11 is an explanatory diagram illustrating task sharing between dealers in the same embodiment, with a purchasing subsidiary and a dealer being mentioned as their representatives.

FIG. 12 is a diagram illustrating the function of purchased merchandise classification management means in the same embodiment.

FIG. 13 is a diagram illustrating the function of approval route management means in the same embodiment.

FIG. 14 is a diagram illustrating the operation of approval route management means in the same embodiment.

FIG. 15 is a diagram illustrating the function of power setting means in the same embodiment.

FIG. 16 is a diagram illustrating the operation of purchasing system linkage means in the same embodiment.

FIG. 17 is a diagram illustrating the function of supplier linkage means in the same embodiment.

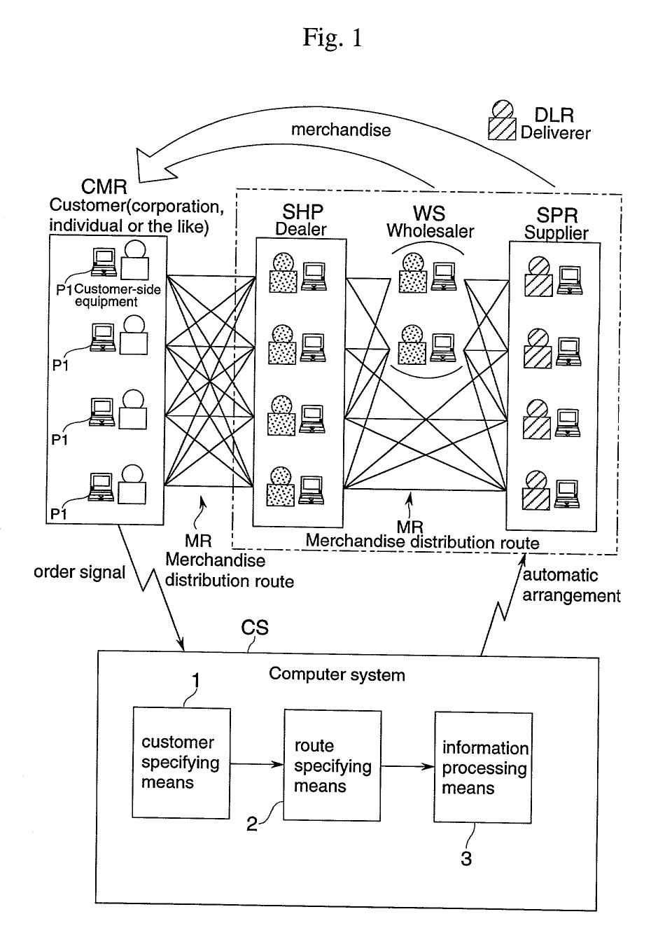

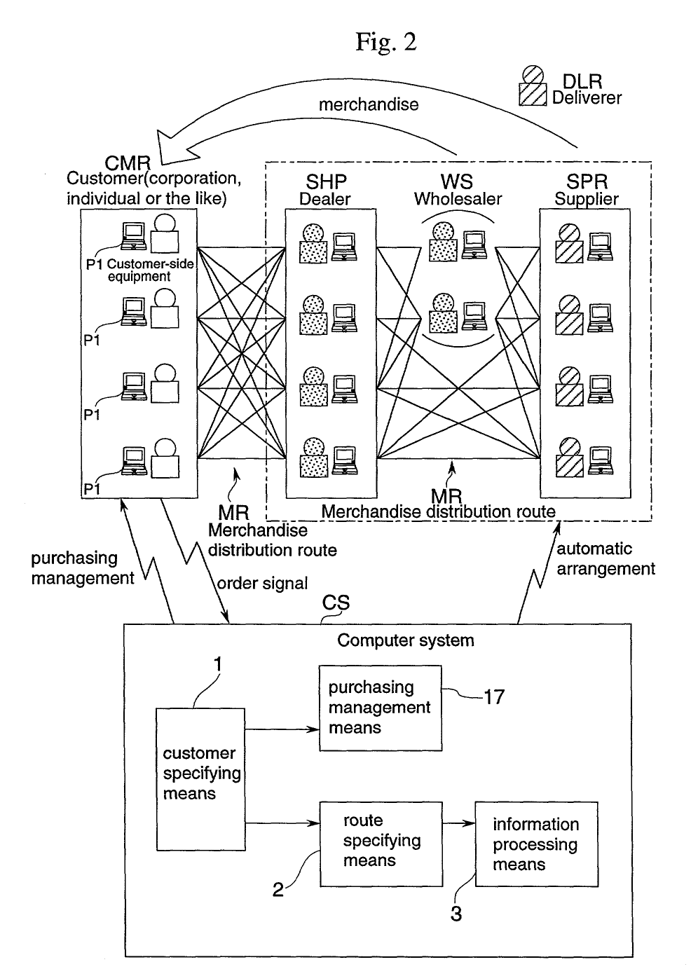

### BEST MODE FOR CARRYING OUT THE INVENTION

Hereinafter, one embodiment of the present invention will be described with reference to the drawings.

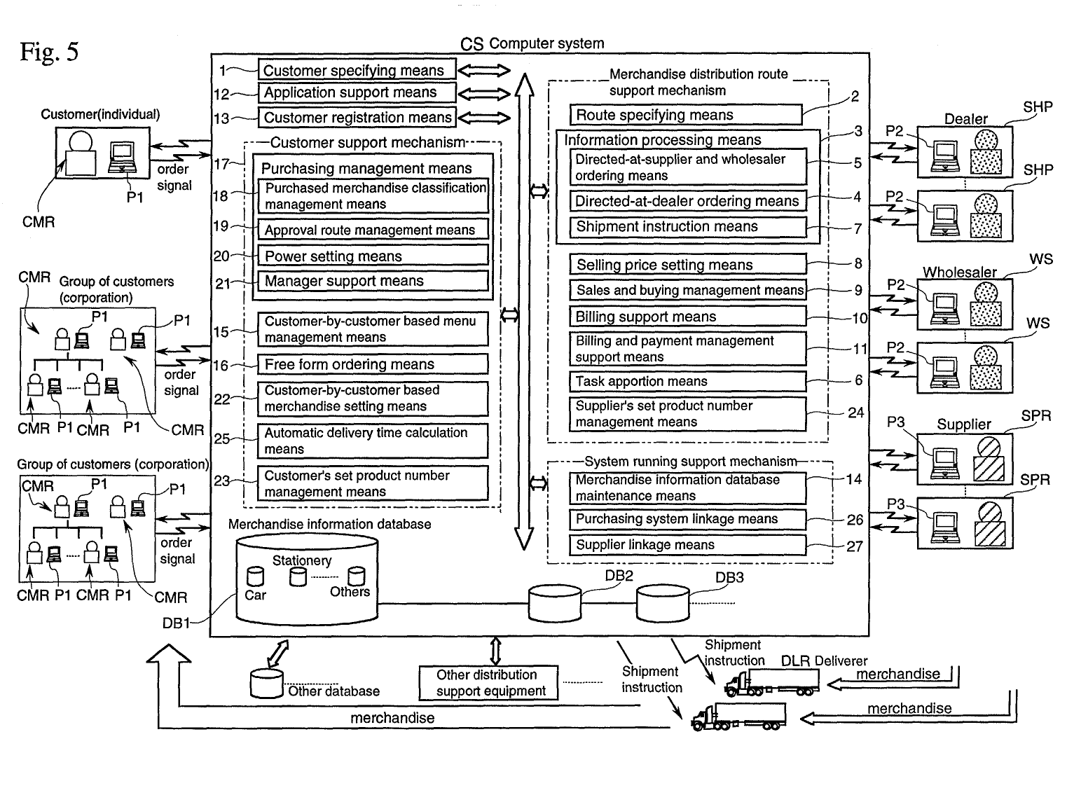

As shown in FIG. 5, distribution support equipment according to this embodiment utilizes terminal devices P1, P2 and P3 provided on the customer CMR side, distributor SHP or WS side and supplier SPR side, respectively, and a computer system CS to support and promote distribution of merchandise dealt through on-line network among these devices and system.

The “customer CMR”, as used herein, is indicative of a user who is registered as authorized to utilize the subject equipment by registration support means to be described later of an unspecified number of users and is established taking account of various forms of customer such as a form as grouped on a corporation-by-corporation basis, a form as grouped on the basis of each division, department or section, or a form as an individual.

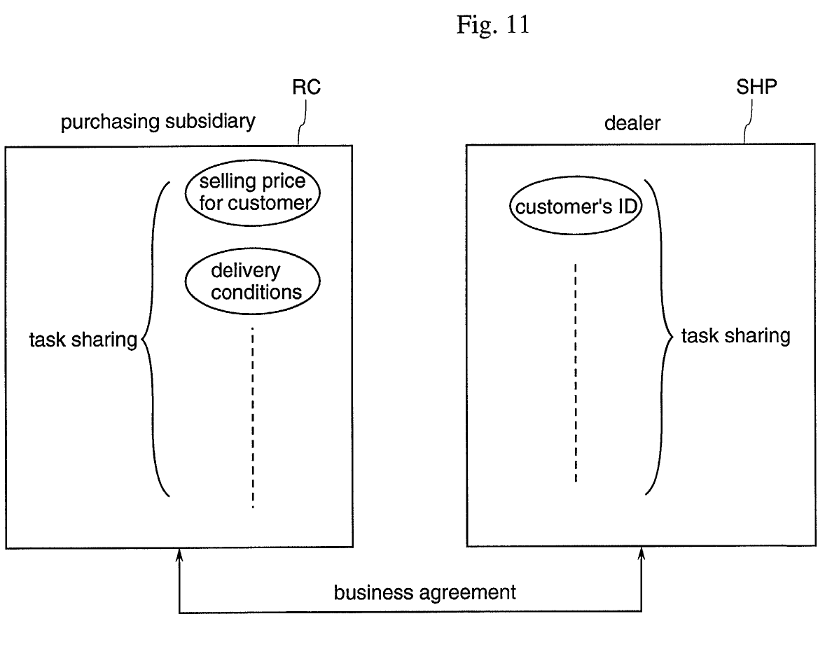

The “distributor” is indicative of one who is registered as authorized to utilize the subject equipment of those functioning in the intermediate process of business dealings such as dealers SHP, wholesalers WS or the like. A purchasing subsidiary RC (as shown in FIG. 11) or the like owned as, for example, an associated company by a customer corporation is included in the category of dealer SHP.

The “supplier SPR” is one who manages merchandise information database DB1 of its own merchandise items and is, so to speak, responsible for providing merchandise. Accordingly, there may be a case where a manufacturer or supplier of merchandise plays the role of the supplier SPR or a case where one who gives instructions to such a manufacturer or the like plays the role of the supplier SPR.

Description is made first of the configuration of devices or apparatuses used to construct the distribution support equipment. Terminal devices P1 to P3 are each a concept encompassing a so-called personal computer as well as a facsimile apparatus, telephone and the like. Though there may be a case where these devices or apparatuses are used in combination in the practice of the present invention, the following description is directed to the case where the terminal devices P1 to P3 are each a personal computer. The location of each of the terminal devices P1 to P3 may be in a home country or a foreign country.

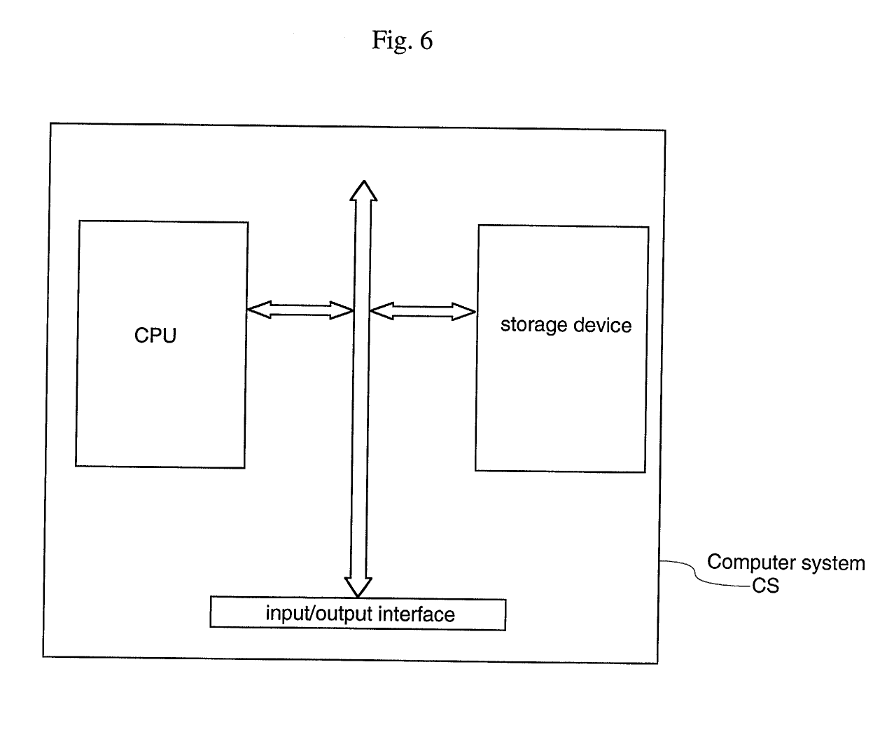

As shown in FIGS. 5 and 6, the computer system CS includes a CPU, an input/output interface, a storage device and the like and serves to manage a WWW server, a FTP server and the like as well as the aforementioned database and peripheral devices. The computer system CS is provided with software for realizing various functions forming the basis of the distribution support equipment and has a function of communications with the outside. The computer system CS may be installed as collected at one location or as dispersed. The location where the computer system is installed may be in a home country or a foreign country.

In the storage device are stored the aforementioned software, merchandise information database DB1 accumulating information of all the merchandise handled by the distribution support equipment, various data derived from the merchandise information, billing condition database DB2 storing various billing conditions related to, for example, delivery and shipment, and the like. The “merchandise information”, as referred to herein, is indicative of standard information managed in a centralized manner such as names, product numbers, merchandise categories and the like of merchandise items standardized in the distribution support equipment. The “outside”, as referred to herein, means the customer-side equipment P1 being a terminal device installed on the customer CMR side, distributor-side equipment P2 being a terminal device installed on the dealer SHP side or the wholesaler WS side, supplier-side equipment P3 being a terminal device installed on the supplier SPR side, or the like.

Next, different functions of the distribution support equipment realized by the software are described.

As shown in FIG. 5, the distribution support equipment includes customer specifying means 1 for specifying a customer CMR who has made access to the computer system CS from the customer-side equipment P1 and customer information thereof, route specifying means 2 for specifying each of merchandise distribution routes MR for plural sorts of merchandise by separating one route from another upon receipt of order signals at a time from the customer CMR specified by the customer specifying means 1 to deliver the plural sorts of merchandise to the customer CMR, information processing means 3 for making arrangements for providing the customer CMR with merchandise items meeting the order signals through respective merchandise distribution routes MR specified by the route specifying means 2, and purchasing management means 17 for automatically performing purchasing management on a customer-by-customer basis according to preset purchasing management conditions determined by a combination of the customer CMR and customer information thereof specified by the customer specifying means 1 and the product number of an merchandise item ordered by the customer CMR.

In this configuration, the route specifying means 2 and the information processing means 3 chiefly exercise the function of what should be called a merchandise distribution support mechanism for simplifying the merchandise distribution process on the merchandise supplier side including distributors SHP or WS and suppliers SPR, while the purchasing management means 17 chiefly exercises the function of what should be called a customer's purchase support mechanism for automatically performing purchasing management within the customer CMR side thereby contributing to labor saving.

Specifically, the customer specifying means 1 serves to specify a customer CMR who has made access to the computer system CS as well as customer information related to a corporation, division, department, section or the like to which the customer CMR belongs on the basis of a registered ID input by the customer CMR. The distribution support equipment is adapted to allow a user to be registered as a customer CMR in an on-line fashion by utilizing application support means 12 included in the subject equipment when the user makes access to the computer system CS. At the time of application for registration, the user is allowed to reference data of dealers SHP previously registered and to designate a specific dealer SHP. On the other hand, the dealer SHP thus designated is allowed to register the user as its own customer CMR in the computer system CS by utilizing customer registration means 13 included in the subject equipment.

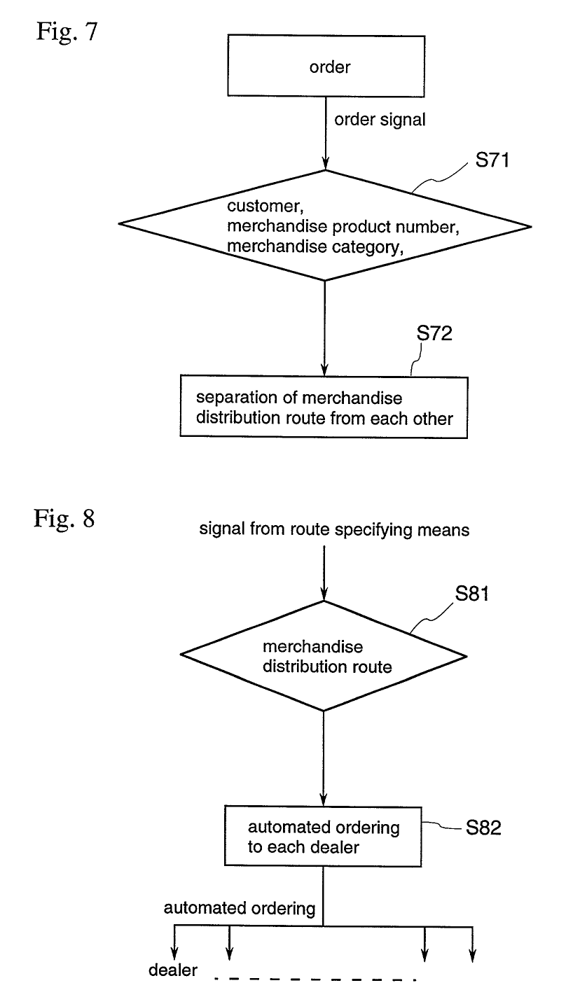

As shown in FIG. 7, the route specifying means 2 uses as parameters a customer CMR giving an order for merchandise items and the product numbers and category units of the merchandise items (step S71) and automatically separates merchandise distribution routes MR from each other to specify respective route through which each of the merchandise items is delivered to the customer CMR from which of distributors and from which of suppliers SPR according to predetermined settings (step S72). The predetermined settings are the contents of an agreement made between a customer CMR and a dealer SHP involved in each merchandise distribution route MR which have been previously registered in the subject equipment and stored in a database, for example. According to the predetermined settings, a dealer SHP, a supplier SPR and the like are designated for each item or category of merchandise ordered by the customer CMR.

The information processing means 3 serves to make arrangements for providing the customer CMR with merchandise ordered as described above and includes directed-at-dealer ordering means 4, directed-at-supplier and wholesaler ordering means 5, and shipment instruction means 7.

As shown in FIG. 8, the directed-at-dealer ordering means 4 follows each merchandise distribution route MR specified by the route specifying means 2 in response to order signals received at a time from the customer CMR (step S81), and automatically places orders to dealers SHP as order receivers of respective merchandise distribution routes MR in an on-line fashion (step S82).

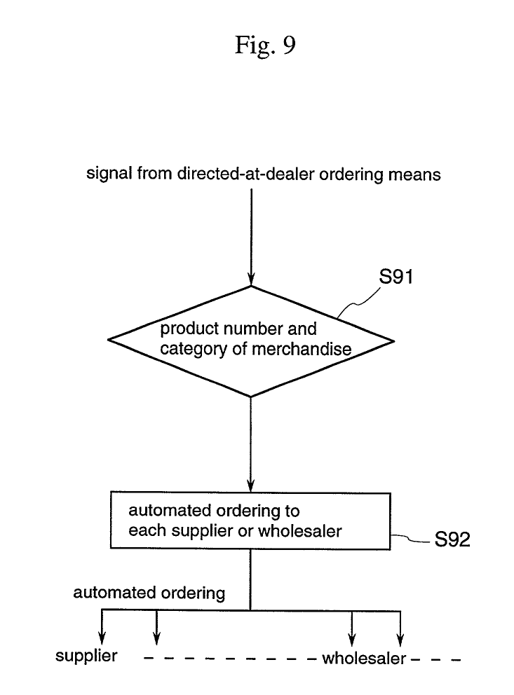

As shown in FIG. 9, the directed-at-supplier and wholesaler ordering means 5 allows a dealer SHP having received orders from the customer CMR through the directed-at-dealer ordering means 4 to reference the product number and merchandise category of each merchandise item (step S91) and to automatically give orders to different suppliers SPR in an on-line fashion on the basis of the product number basis and merchandise category of each merchandise item according to predetermined settings (step S92). In the case where a wholesaler WS is involved in a merchandise distribution route MR specified, the directed-at-supplier and wholesaler ordering means 5 also plays a role of automatic order receiving and automatic ordering on behalf of the wholesaler WS. Taking account of a case where wholesalers WS are involved at multiple stages of a merchandise distribution route MR, it is possible to provide multi-stage wholesaler management means for automatically managing the merchandise distribution route MR according to predetermined settings.

Though not particularly shown in detail, the shipment instruction means 7 allows a dealer SHP, wholesaler WS or supplier SPR having received orders from the customer CMR to automatically give instructions to different deliverers DLR depending upon areas and ordered merchandise items according to predetermined settings. In giving shipment instructions, the dealer SHP or the like who requests shipment is disclosed to the deliverers DLR.

In order to assist the information processing means 3 in simplification and labor saving of distribution in relation to business dealings on the merchandise supplier side including distributors SHP and WS, suppliers SPR and the like, this embodiment is further provided with sales setting means 8, sales and buying management means 9, billing support means 10, billing and payment management support means 11, task apportion support means 6, and supplier's set product number management means 24.

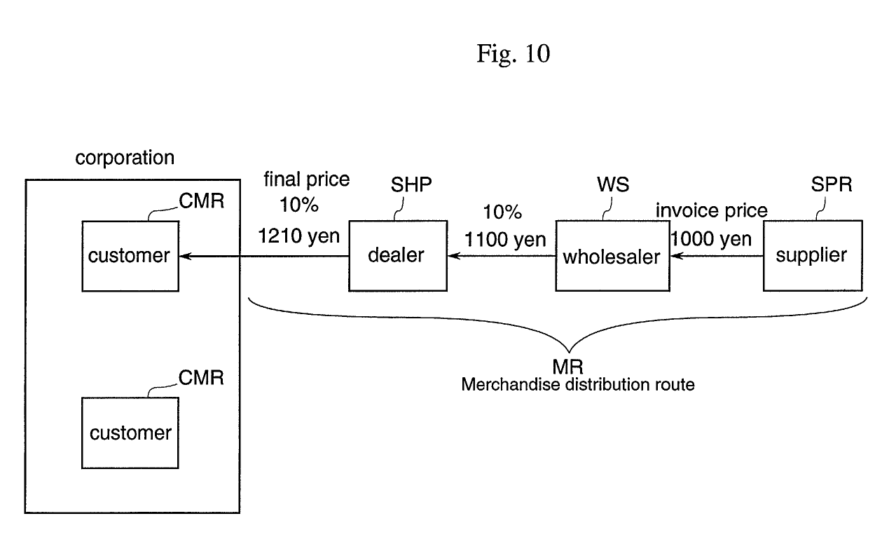

As shown in FIG. 10, the sales setting means 8 serves to automatically set a final selling price of a merchandise item for a customer CMR giving an order for the merchandise item by adding a profit ratio for a distributor SHP or WS involved in a merchandise distribution route MR specified by the route specifying means 2 to a selling price of the merchandise item set by a supplier SPR.

Though not particularly shown in detail, the sales and buying management means 9 serves to manage unit selling price and unit buying price for each distributor or supplier SPR according to predetermined settings and to automatically provide each distributor SHP or WS with sales and buying information based on delivery information.

Though not particularly shown in detail, the billing support means 10 serves to automatically calculate expenses such as delivery cost, setup cost and layout cost and provide a billed part with information of the expenses thus calculated according to billing conditions in relation to delivery, distribution and the like stored in a billing condition database DB2 when the billed part wants the information.

Though not particularly shown in detail, the billing and payment management support means 11 serves to support billing and payment management at each supplier SPR or each distributor SHP or WS on the basis of sales and buying information according to predetermined settings by automatically creating a document form or data form of, for example, a delivery invoice, receipt by inspection, slip, specification, payment notice, and billing manner and providing such form to one who wants it.

As shown in FIG. 11, the task apportion support means 6 is effective for a customer corporation which, for example, owns a purchasing subsidiary RC which takes any one of various forms of business dealings, including a form such that this purchasing subsidiary RC exercises all the tasks of a dealer SHP, a form such that the task of delivering merchandise to the corporation is shared between the purchasing subsidiary RC and a dealer SHP, and a form such that the purchasing subsidiary RC has a tie-up with another corporation as well as with the parent corporation and shares tasks with a dealer of the other corporation. Specifically, the task apportion support means 6 serves to allow the purchasing subsidiary and the dealer SHP to share the tasks, such as customer's ID setting, customer selling price setting and delivery condition setting, which are inherent to a dealer function and are to be automated by the subject distribution support equipment on a task-by-task basis according to an agreement previously made between the purchasing subsidiary RC and the dealer SHP.

Though not particularly shown in detail, the supplier's set product number management means 24 serves to establish a set of product numbers of plural merchandise items for which a supplier SPR is capable of receiving an order if the merchandise items are combined into a finished product and which are established as plural merchandise items in the computer system CS thereby enabling an order based on a single set product number.

The computer system CS incorporates databases DB3 for each dealer SHP, each wholesaler WS and each supplier SPR in each of which is stored information to be transmitted from the computer system CS to them, for example, situation of orders and receipt of orders, delivery situation, sales amount, buying information, slips, specification or the like, in the form of a data file. Each dealer SHP or the like is permitted to utilize such information by making access to the computer system CS and browsing, downloading or printing out its own data file stored in each database DB3.

The purchasing management means 17 is described in detail below. The purchasing management means 17 includes purchased merchandise classification management means 18, approval route management means 19, power setting means 20, and manager support means 21.

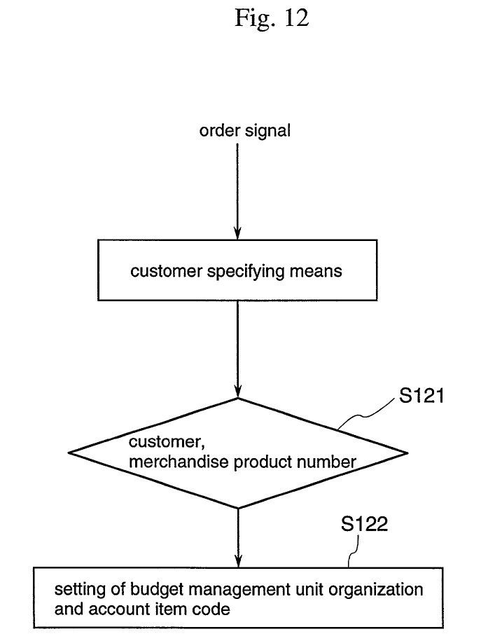

As shown in FIG. 12, the purchased merchandise classification management means 18 serves to combine a customer CMR and its customer information specified by the customer specifying means 1 and the product number of a merchandise item ordered by the customer CMR (step S121) and to automatically set and manage a budget management organization unit and an account item code which are used in an organization to which the customer CMR belongs depending upon the combination thus made (step S122).

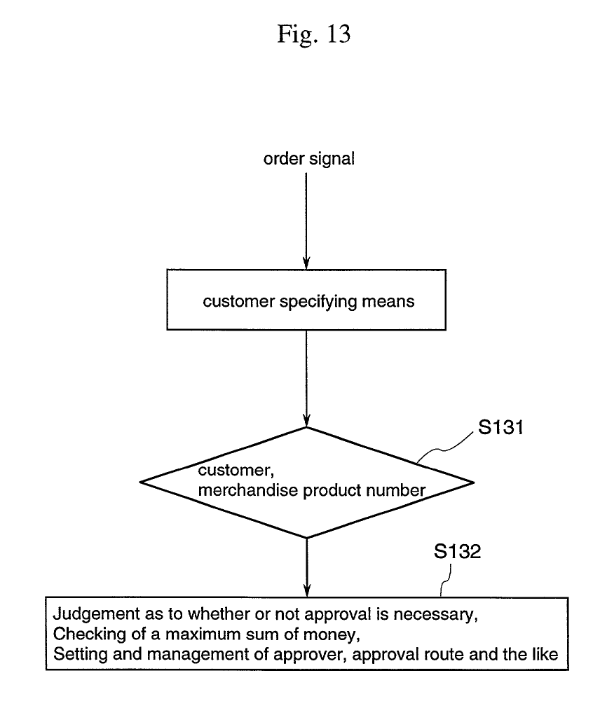

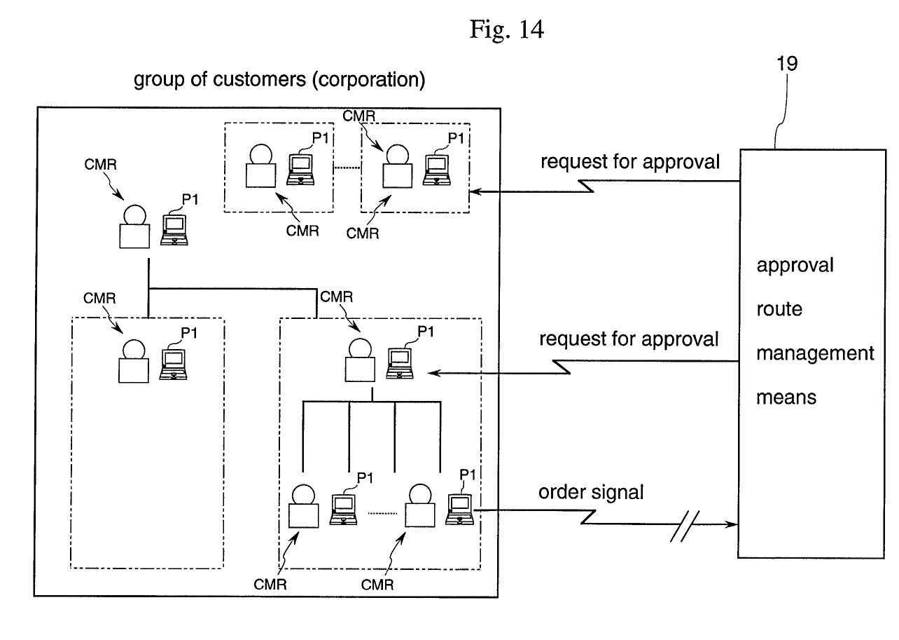

As shown in FIG. 13, the approval route management means 19 serves to combine a customer CMR specified by the customer specifying means 1 and the product number of a merchandise item ordered by the customer CMR (step S131) and to automatically perform purchasing management related to a judgment as to whether or not approval is necessary, a maximum sum of money, approver, approval route and the like on the basis of the combination thus made according to purchasing regulations stipulated by an organization to which the customer CMR belongs or legal regulations (step S132). More specifically, when one customer CMR belonging to a corporation places an order for a merchandise item, the approval route management means 19 serves to automatically forward a request for approval in the form of electronic mail or the like to a customer's superior or the head of a department or office previously appointed depending on the category or price of the ordered merchandise item in order to obtain approval thereof, as shown in FIG. 14.

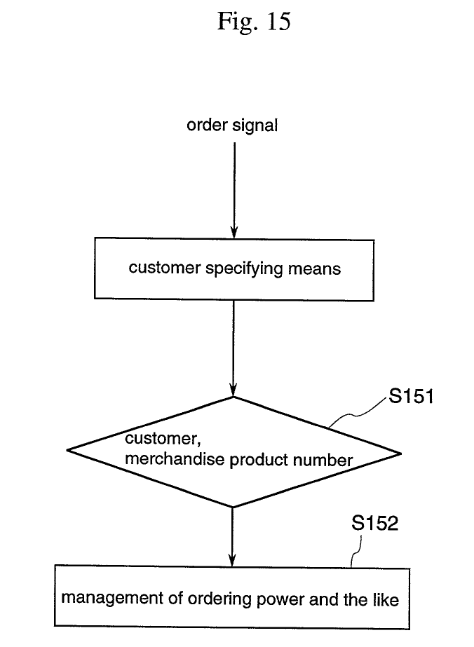

As shown in FIG. 15, the power setting means 20 serves to combine a customer CMR specified by the customer specifying means 1 and the product number of a merchandise item ordered by the customer CMR (step S151) and to manage the entitlement of the customer CMR to placing orders in an organization to which the customer CMR belongs and judge whether each customer CMR is entitled to a referencing power or an ordering power depending upon the combination thus made (step S152). A conceivable example of the power setting means 20 has a setting such as to change merchandise items on a screen that can be ordered depending upon the position or post of the customer CMR.

Though not particularly shown in detail, the manager support means 21 serves to provide a manager in an organization to which a customer CMR belongs with purchasing information of each customer CMR in the organization thereby allowing the manager to conduct centralized management of a purchase budget of the organization.

In order to assist the purchasing management means 17 in improving the convenience for ordering of merchandise and management performed on the customer CMR side, the subject embodiment is further provided with customer-by-customer based menu management means 15, free form ordering means 16, customer-by-customer based merchandise setting means 22, customer's set product number management means 23, and automatic delivery time calculation means 25.

Though not particularly shown in detail, the customer-by-customer based menu management means 15 enables setting of URL original with each customer CMR and setting of an initial picture displayed on the customer-side equipment P1 on a customer-by-customer basis according to predetermined settings and allows necessary functions (menu) to be customized in an on-line fashion on a customer-by-customer basis. When, for example, a customer CMR does not require all the merchandise information stored in the merchandise information database DB1, the customer-by-customer based menu management means 15 functions to provide a setting such as to retrieve or select merchandise items belonging only to merchandise categories that are necessary for the customer CMR.

Though not particularly shown in detail, the free form ordering means 16 serves to allow a customer CMR to designate a previously registered dealer SHP to which the customer CMR is capable of addressing an inquiry about an order for a merchandise item which has previously not been established through the customer-side equipment P1 as well as to perform sales management handling the merchandise item as a special handling merchandise item according to an agreement previously made between the customer CMR and the dealer SHP in relation to the inquiry. The free form ordering means 16 is preferable for the customer CMR because it allows the subject equipment to handle an unregistered specially ordered merchandise item, for example, a name-attached pen in the same manner as with other common merchandise items if only an agreement in relation to such merchandise items has been previously made between the customer CMR and the dealer SHP thereby enabling flexible ordering.

Though not particularly shown in detail, the customer-by-customer based merchandise setting means 22 serves at least to establish settings of original categories and names of merchandise items as “typical merchandise item” or “usable in . . . environment” on a customer-by-customer basis aside from categories and names of handleable merchandise items established in the computer system CS, allow a customer's own mark image to be displayed, and enable merchandise item retrieval based on the setting thus made.

Though not particularly shown in detail, the customer's set product number management means 23 serves to allow a customer CMR to establish a plurality of product numbers as a set aside from product numbers of merchandise items established in the computer system CS thereby enabling management based on a customer's own single set product number and to place an order also based on the set product number.

Though not particularly shown in detail, the automatic delivery time calculation means 25 serves to automatically calculate a due date for delivery of a merchandise item ordered by a customer CMR by referencing the deliverable area covered by a deliverer DLR designated as a deliverer of the merchandise item ordered, deliverable merchandise items, working dates of the customer CMR (conditions required by the customer), account closing conditions of the deliverer DLR and delivery conditions. The subject equipment may be configured to utilize the automatic delivery time calculation means 25 to check whether the merchandise item ordered by the customer CMR can be delivered to the customer CMR on a desired delivery date if designated by the customer CMR.

In addition, the subject embodiment realizes what should be called a system running support mechanism for smooth running and enhanced extensibility of the distribution support equipment by mainly utilizing merchandise information database maintenance means 14, purchasing system linkage means 26, and supplier linkage means 27.

Though not particularly shown in detail, the merchandise information database maintenance means 14 serves to store information of handleable merchandise items in a merchandise information database DB1 incorporated in the computer system CS and allow a supplier SPR contacting the computer system CS to register information of at least merchandise items supplied from the supplier SPR itself in the merchandise information database DB1 or renew the information registered in the database DB1.

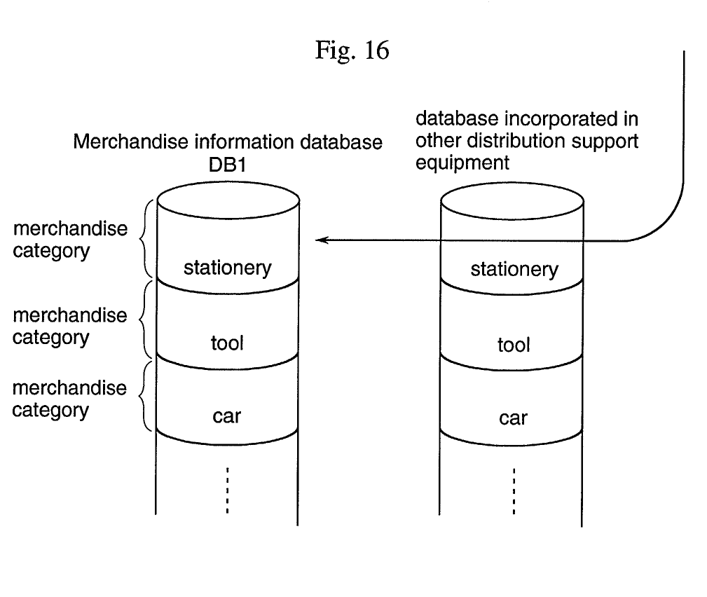

As shown in FIG. 16, the purchasing system linkage means 26 is for linking up with other distribution support equipment and serves to provide customers CMR utilizing the other distribution support equipment with merchandise information stored in the computer system CS of the subject equipment as information of an original merchandise assortment and purchase prices previously established on a customer-by-customer basis by matching merchandise categories established in the computer system CS with those established in the other distribution support equipment. As used herein, “matching merchandise categories established in the computer system CS with those established in the other distribution support equipment” is to correlate merchandise categories in the computer system CS with the corresponding ones, if present, in the other equipment or establish in the computer system CS new merchandise categories corresponding to those established in the other equipment but not found in the computer system CS. Thus, a customer CMR becomes capable of utilizing the subject distribution support equipment by using as a window the distribution support equipment being used by the customer CMR. It should be noted that the subject embodiment is configured to provide the customer CMR with the merchandise information stored in the subject distribution support equipment after having fully removed the merchandise information in the other distribution support equipment.

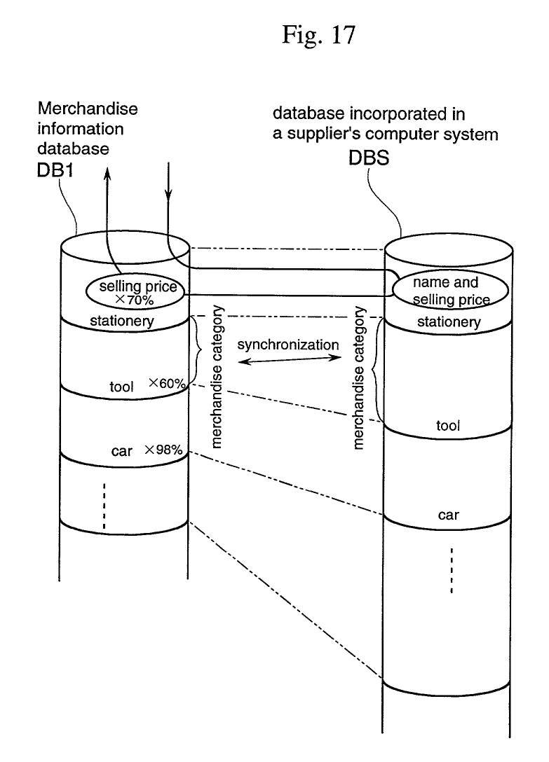

As shown in FIG. 17, the supplier linkage means 27 is for linking up with a supplier SPR having an original computer system accumulating its own merchandise information and serves to enable the merchandise information to be taken out through the computer system CS of the subject equipment. More specifically, the supplier linkage means 27 is configured to enable the merchandise information accumulated in the supplier's computer system CS to be utilized as if it were merchandise information stored in the computer system CS of the subject equipment so as to enable purchase of a merchandise item based on the merchandise information by synchronizing merchandise categories established in the computer system CS of the subject equipment with those established in the database incorporated in the supplier's computer system and applying a ratio variable price established for each merchandise category to a selling price of a merchandise item belonging to each merchandise category established in the supplier's computer system CS. Accordingly, even if the merchandise information in the merchandise information database DB1 is insufficient, the customer CMR can obtain sufficient merchandise information as long as the supplier SPR has a database.

The distribution support equipment is utilized as follows.

Assume that a customer CMR belongs to a corporation for example and this customer CMR retrieves and selects merchandise items through the customer-side terminal device P1 and places orders for merchandise items A, B and C belonging to different categories at a time by transmitting order signals.

First, the customer CMR and the corporation to which the customer CMR belongs are specified by the customer specifying means 1 from the customer's ID input.

Subsequently, the approval route management means 19 forming part of the purchasing management means 17 acts to automatically judge whether or not approval is necessary and find out a maximum sum of money, approver and approval route with respect to each of the merchandise items according to the purchase regulations stipulated by the corporation and to automatically address a request for approval to a customer's superior or the like if approval is necessary. If the purchasing of each merchandise item is approved, the purchased merchandise classification management means 18 automatically set and manage a budget management organization unit and an account item code used in the corporation.

When the orders have been thus placed formally, the route specifying means 2 acts to separate merchandise distribution routes MR for respective merchandise items A, B and C from each other according to the predetermined settings using the customer's ID, product numbers and category units of the merchandise items contained in the order signals as parameters.

In turn, the information processing means 3 acts to automatically give orders to a dealer SHP, wholesaler WS and supplier SPR involved in each merchandise distribution route MR established for each of the merchandise items A, B and C as well as to automatically give shipment instructions to different deliverers DLR selected depending upon deliverable areas and ordered merchandise items. It is to be noted that actually the dealer SHP and the wholesaler WS merely receive a notification to the effect that the orders have been given and do not need to make any arrangement for the merchandise items.

Thereafter, the deliverers DLR receiving delivery instructions deliver the merchandise items A, B and C to the customer CMR.

At the same time with such merchandise ordering process and delivery arrangement process, the delivery dates and the prices of the merchandise items A, B and C are automatically notified to the customer CMR. The distributor SHP or WS and the supplier SPR, on the other hand, are given information of orders and received orders, delivery information and the like, and various procedures and management in relation thereto are automatically performed. Thus, there is performed a virtual process as same as a process actually performed to deliver the merchandise items through the distributor SHP, wholesaler WS and supplier SPR involved in respective merchandise distribution route MR.

Accordingly, with the subject embodiment, the customer CMR side can promote labor saving and simplification in relation to conventional ordering tasks and management because, for example, plural sorts of merchandise can be ordered at a time by virtue of the customer's purchase support mechanism and even the internal tasks related to purchase of merchandise can be automated. The distributor SHP or WS side or the supplier SPR side, on the other hand, can simplify the physical distribution and lower the cost thereof as well as save the labor required for transactions in relation to arrangements for merchandise which would otherwise be separately done by each distributor or supplier because the merchandise distribution support mechanism automatically separates merchandise distribution routes for respective merchandise items from each other and automates the dealing process up to the completion of delivery of merchandise to the customer CMR through respective merchandise distribution route MR thereby realizing centralized management.

Stated otherwise, the subject embodiment makes it possible to support an overall actual business to which a plurality of distributors including dealers SHP and a plurality of suppliers SPR attend for a customer CMR, thereby enhancing the merchandise distribution efficiency and cost reduction of an overall business dealing without impairing the advantages of the existing business order, namely the necessary advantages obtained from services and the like provided by persons acting physically. Particularly where there is a group of customers CMR such as a corporation and diversified amounts and sorts of merchandise are handled, the distribution support equipment becomes highly effective.

Further, since the system running support mechanism provided in the subject embodiment enhances the smooth running and extensibility of the distribution support equipment, the equipment can flexibly accommodate to such a case that changes occur in the form of business dealings in the future or that each dealer or supplier or each customer CMR wishes to utilize its own system in cooperation with the distribution support equipment, and like cases.

It should be noted that the present invention is not limited to the embodiment described above. For example, an embodiment comprising only the distribution support mechanism or the customer-side support mechanism is conceivable. Also conceivable is an embodiment in which a supplier SPR also acts as a wholesaler WS or a dealer SHP.

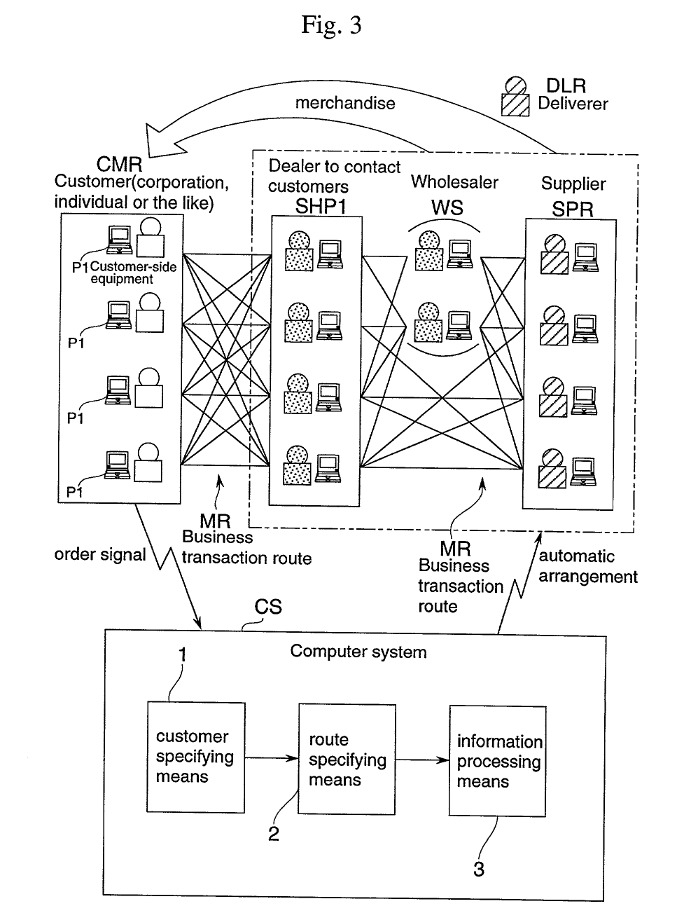

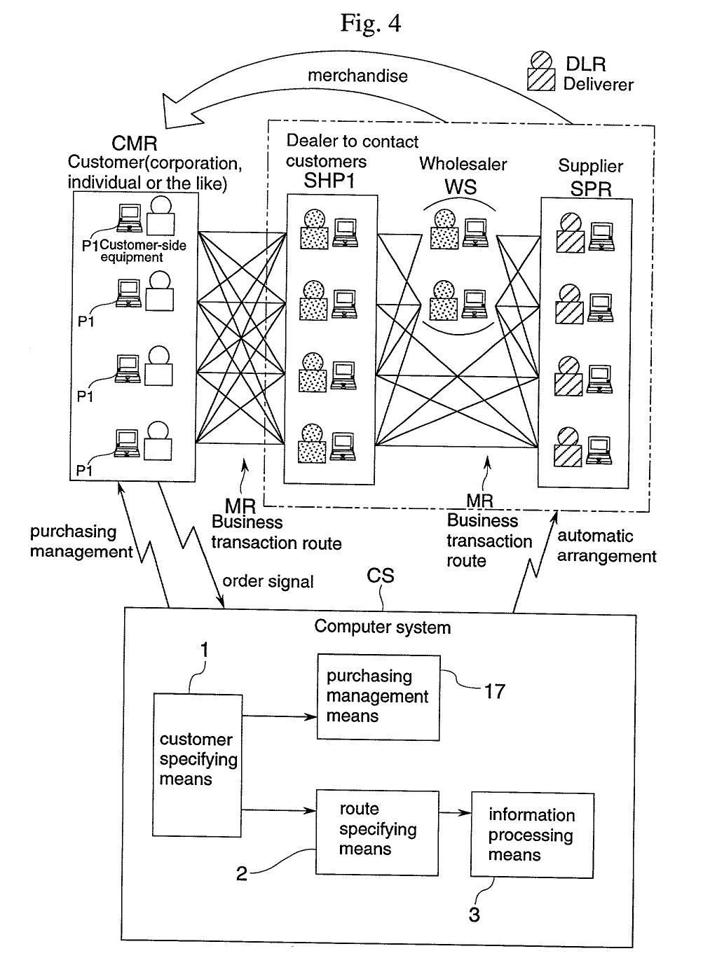

Further, it is possible to accommodate to even businesses providing services such as rental service, laundry service, cleaning service and care service by applying the distribution support equipment to each business as shown in FIGS. 3 and 4. In this case, SHP1 who acts as a window contacting customers corresponds to a dealer SHP.

The present invention is not limited to the foregoing embodiments shown in the drawings and may be variously modified without departing the spirit of the present invention.

As has been described in detail, the present invention allows a customer to place orders for plural sorts of merchandise at a time even if the merchandise category and merchandise distribution route of one merchandise item are completely different from those of another merchandise item, whereby the ordering operation can be rendered highly simplified and convenient. Further, since the route specifying means separates merchandise distribution routes for respective merchandise items from each other and the information processing means automates the process up to the completion of delivery of merchandise to a customer though respective merchandise distribution route, it is possible to eliminate or minimize the task of arranging for merchandise or the like which would otherwise be done by each distributor such as a dealer or wholesaler or each supplier.

Stated otherwise, the present invention makes it possible to support an overall actual business dealing to which a plurality of distributors including dealers and a plurality of suppliers attend for a customer, thereby enhancing the merchandise distribution efficiency and cost reduction of an overall business dealing without impairing the advantages of the existing business order, namely the necessary advantages brought by persons acting physically. Particularly where there is a group of customers such as a corporation and diversified amounts and sorts of merchandise are handled, the present invention becomes highly effective.

If the distribution support equipment is provided with the purchasing management means for automatically managing the purchasing of a customer according to purchasing management conditions determined by a combination of the customer specified by the customer specifying means and the product number of a merchandise item ordered by the customer, labor saving in relation to the customer's task of ordering merchandise can be accelerated.

It is needless to say that the distribution support equipment of the present invention can be used more conveniently if various other means for assisting or supporting the information processing means and purchasing management means are included in the equipment.

Further, if the distribution support equipment is provided with the customer registration means, merchandise information database maintenance means, purchasing system linkage means or like means for enhancing the smooth running and extensibility of the distribution support equipment, the equipment can flexibly accommodate to such a case that changes occur in the form of business dealings in the future or that each dealer or supplier or each customer CMR wishes to utilize its own system in cooperation with the distribution support equipment, and like cases.

### INDUSTRIAL APPLICABILITY

As described above, the distribution support equipment according to the present invention makes it possible to enhance the efficiency and cost reduction of an overall business dealing while retaining the existing business dealing system in which intermediate distributors are involved to take the advantages of the existing business dealing system.

1. Distribution support equipment configured to be run with use of a computer system and customer-side equipment accessible to the computer system through a communication channel for supporting distribution related to business dealings among customers, distributors including dealers and wholesalers, and suppliers, characterized by comprising:
customer specifying means for specifying a customer who has made access to the computer system from the customer-side equipment;
route specifying means for specifying each of merchandise distribution routes for plural sorts of merchandise by separating one route from another upon receipt of order signals from the customer specified by the customer specifying means to deliver the plural sorts of merchandise to the customer; and
information processing means for making arrangements for providing the customer with merchandise items meeting the order signals through respective merchandise distribution routes specified by the route specifying means.

2. The distribution support equipment in accordance with claim 1, wherein the route specifying means is configured to separate the merchandise distribution routes from each other on the basis of the product number and category of each of the merchandise items according to predetermined settings.

3. The distribution support equipment in accordance with claim 1 or 2, the information processing means is provided with directed-at-dealer ordering means for automatically placing orders to dealers serving as order receivers of respective merchandise routes according to the order signals received from the customer at a time.

4. The distribution support equipment in accordance with any one of claims 1 to 3, wherein the information processing means is provided with directed-at-supplier and wholesaler ordering means for allowing a dealer having received orders from the customer to automatically place orders to different suppliers or wholesalers depending upon product numbers and categories of ordered merchandise items according to predetermined settings.

5. The distribution support equipment in accordance with any one of claims 1 to 4, wherein the information processing means is provided with shipment instruction means for allowing a dealer having received orders from the customer to automatically give shipment instructions to different deliverers depending upon areas and ordered merchandise items according to predetermined settings.

6. The distribution support equipment in accordance with any one of claims 1 to 5, which is provided with selling price setting means for automatically setting a final selling price of a merchandise item for a customer giving an order for the merchandise item by adding a profit ratio for a distributor involved in a merchandise distribution route specified by the route specifying means to a selling price set by a supplier.

7. The distribution support equipment in accordance with any one of claims 1 to 6, which is provided with sales and buying management means for managing unit selling price and unit buying price for each distributor or supplier according to predetermined settings while automatically providing each distributor with sales and buying information based on delivery information.

8. The distribution support equipment in accordance with any one of claims 1 to 7, which is provided with billing support means for automatically calculating expenses and providing a billed part with information of the expenses thus calculated according to billing conditions stored in a billing condition database storing various billing conditions in relation to delivery, distribution and the like when the billed part wants the information.

9. The distribution support equipment in accordance with any one of claims 1 to 8, which is provided with billing and payment management support means for supporting billing and payment management at each supplier or distributor on the basis of sales and buying information according to predetermined settings.

10. The distribution support equipment in accordance with any one of claims 1 to 9, which is provided with task apportion support means for allowing dealers to apportion a power of setting in respect of sharing of tasks inherent to a dealer function including customer's ID setting, customer selling price setting and delivery condition setting on a task-by-task basis according to an agreement previously made between the plurality of dealers having overlapping tasks.

11. The distribution support equipment in accordance with any one of claims 1 to 10, which is provided with purchasing management means for automatically performing purchasing management of a customer according to purchasing management conditions determined by a combination of the customer and customer information specified by the customer specifying means and the product number of a merchandise item ordered by the customer.

12. The distribution support equipment in accordance with claim 11, wherein the purchasing management means is provided with purchased merchandise classification management means for automatically setting and managing an account item code used in an organization to which the customer belongs depending upon a combination of the customer and customer information comprising a budget management unit in the organization specified by the customer specifying means and the product number of a merchandise item ordered by the customer.

13. The distribution support equipment in accordance with claim 11 or 12, wherein the purchasing management means is provided with approval route management means for automatically performing purchasing management related to a judgment as to whether or not approval is necessary, a maximum sum of money not requiring approval, an approver, an approval route and the like according to purchase regulations stipulated by the organization to which a customer belongs depending upon a combination of the customer and customer information specified by the customer specifying means and the product number of a merchandise item ordered by the customer.

14. The distribution support equipment in accordance with any one of claims 11 to 13, wherein the purchasing management means is provided with power setting means for managing the entitlement of a customer to placing orders in an organization to which the customer belongs while judging whether each customer is entitled to a referencing power or an ordering power.

15. The distribution support equipment in accordance with any one of claims 11 to 14, wherein the purchasing management means is provided with manager support means for providing a manager in an organization to which a customer belongs with purchasing information of each customer in the organization thereby allowing the manager conduct centralized management of a purchase budget of the organization.

16. The distribution support equipment in accordance with any one of claims 1 to 15, which is provided with customer-by-customer based menu management means for enabling customization of setting of a picture displayed on the customer-side equipment and necessary functions of the customer-side equipment on a customer-by-customer basis.

17. The distribution support equipment in accordance with any one of claims 1 to 16, which is provided with free form ordering means for allowing a customer to designate a previously registered dealer to which the customer is capable of addressing an inquiry about an order for a merchandise item which has previously not been established through the customer-side equipment as well as for performing sales management handling the merchandise item as a special handling merchandise item according to an agreement made between the customer and the dealer in relation to the inquiry.

18. The distribution support equipment in accordance with any one of claims 1 to 17, which is provided with customer-by-customer based merchandise setting means for establishing at least settings of original categories, names and the like of merchandise items on a customer-by-customer basis aside from categories and names of handleable merchandise items established in the computer system as well as for enabling merchandise item retrieval based on the settings thus made.

19. The distribution support equipment in accordance with any one of claims 1 to 18, which is provided with customer's set product number management means for allowing a customer to establish a plurality of product numbers as a set aside from product numbers of merchandise items established in the computer system thereby enabling management based on a customer's own single set product number and to place an order also based on the set product number.

20. The distribution support equipment in accordance with any one of claims 1 to 19, which is provided with supplier's set product number management means for establishing a set of product numbers of plural merchandise items for which a supplier is capable of receiving an order if the merchandise items are combined into a finished product and which are established as plural merchandise items in the computer system thereby enabling an order based on a single set product number.

21. The distribution support equipment in accordance with any one of claims 1 to 20, which is provided with automatic delivery time calculation means for automatically calculating a due date for delivery of a merchandise item ordered by a customer by referencing at least delivery situation of a deliverer and working dates of the customer.

22. The distribution support equipment in accordance with any one of claims 1 to 21, which is provided with application support means for registering an unspecified number of users having made contact with the computer system as customers capable of business dealing through the computer system, the application support means having a function allowing a user to designate a specific dealer by referencing data of dealers previously registered when the user applies for registration.

23. The distribution support equipment in accordance with any one of claims 1 to 22, which is provided with customer registration means for allowing a dealer designated by a user to register the user as a customer of the dealer in the computer system.

24. The distribution support equipment in accordance with any one of claims 1 to 23, which is provided with merchandise information database maintenance means for storing information of handleable merchandise items in a merchandise information database incorporated in the computer system and allowing a supplier contacting the computer system to register information of at least merchandise items supplied from the supplier itself in the merchandise information database or renew the information registered in the database.

25. The distribution support equipment in accordance with any one of claims 1 to 24, which is provided with purchasing system linkage means for linking up with other distribution support equipment and providing customers utilizing the other distribution support equipment with merchandise information stored in the computer system as information of an original merchandise assortment and purchase prices previously established on a customer-by-customer basis by matching merchandise categories established in the computer system with those established in the other distribution support equipment.

26. The distribution support equipment in accordance with any one of claims 1 to 25, which is provided with supplier linkage means for linking up with a supplier having an original computer system accumulating its own merchandise information to obtain the merchandise information through the computer system of the distribution support equipment.

27. The distribution support equipment in accordance with claims 26, wherein the supplier linkage means is configured to enable the merchandise information accumulated in the supplier's computer system to be utilized as merchandise information of the computer system of the distribution support equipment by synchronizing the merchandise categories established in the computer system of the distribution support system with those established in the supplier's computer system and applying a ratio variable price established for each merchandise category to a selling price of a merchandise item belonging to each merchandise category established in the supplier's computer system.

28. Distribution support equipment configured to be run with use of a computer system and customer-side equipment accessible to the computer system through a communication channel for supporting distribution related to business dealings among customers, distributors including dealers and wholesalers, and suppliers, characterized by comprising:
customer specifying means for specifying a customer who has made access to the computer system from the customer-side equipment; and
purchasing management means for automatically performing purchasing management on a customer-by-customer basis according to preset purchasing management conditions determined by a combination of the customer specified by the customer specifying means and a product number of a merchandise item ordered by the customer.

29. Distribution support equipment configured to be run with use of a computer system and customer-side equipment accessible to the computer system through a communication channel, characterized by comprising:
customer specifying means for specifying a customer who has made access to the computer system from the customer-side equipment;
route specifying means for specifying each of business transaction routes for plural sorts of services by separating one route from another upon receipt of order signals at a time from the customer specified by the customer specifying means to provide the customer with the plural sorts of services; and
information processing means for making arrangements for providing the customer with the services meeting the order signals through respective business transaction routes specified by the route specifying means.

30. The distribution support equipment in accordance with claim 29, which is provided with purchasing management means for automatically performing purchasing management on a customer-by-customer basis according to preset purchasing management conditions determined by a combination of the customer specified by the customer specifying means and the sorts of services ordered by the customer.

31. Distribution support equipment configured to be run with use of a computer system and customer-side equipment accessible to the computer system through a communication channel, characterized by comprising:
customer specifying means for specifying a customer who has made access to the computer system from the customer-side equipment; and
purchasing management means for automatically performing purchasing management on a customer-by-customer basis according to preset purchasing management conditions determined by a combination of the customer specified by the customer specifying means and sorts of services ordered by the customer.
